(19) United States
(12) Patent Application Publication
(10) Pub. No.: US 2020/0033870 A1
(43) Pub. Date: Jan. 30, 2020

(54) Fault Tolerant State Estimation

(71) Applicant: Exyn Technologies, Philadephia, PA (US)

(72) Inventor: Jason Derenick, Philadelphia, PA (US)

(21) Appl. No.: 16/521,310

(22) Filed: Jul. 24, 2019

Related U.S. Application Data
(60) Provisional application No. 62/702,530, filed on Jul. 24, 2018.

(51) Int. Cl. G05D 1/02; G05D 1/00; G06K 9/00; G06K 9/62; G06T 7/73; H04W 4/46

(52) U.S. Cl. CPC G05D 1/0221; G05D 1/0236; G05D 1/0027; G05D 1/0251; H04W 4/46; G06K 9/00791; G06K 9/6278; G06T 7/73; G05D 1/0088

(57) ABSTRACT

Certain embodiments of the disclosure can include methods, devices, and systems for state estimation of a robotic vehicle. The embodiments can include training a program with sample and/or simulated data. The vehicle can use this program to plot a course. The vehicle can then supplement the plotted course with data gathered by its sensors, as well as with data gathered by other vehicles. The embodiments can also include evaluating the newly detected data and generating an assessment of the accuracy of the data. Based on the originally plotted course, the detected data, and the assessment of the accuracy of the data, embodiments of the disclosure can then modify the course of the vehicle as desired.

### CROSS REFERENCE TO RELATED APPLICATIONS

The present application claims the benefit of U.S. provisional patent application No. 62/702,530 filed on 24 Jul. 2018, the disclosure of which is incorporated in its entirety herein by reference.

### FIELD OF INVENTION

The present disclosure relates to autonomous vehicle state estimation.

### BACKGROUND

Modern approaches to autonomous state estimation involve capturing expected or nominal sensor behavior under specified operating conditions. When measurements deviate significantly from this model, they are considered, or flagged, as erroneous, and are gated off, or ignored, as input. The effectiveness of this approach relies almost entirely on the limited fidelity of the underlying model of nominal behavior. This often results in systems that employ either overly conservative gating (ignoring ultimately useful information) or overly inclusive gating (including ultimately erroneous information); both of which reduce the accuracy of the state estimate. One example of this type of approach is the standard chi squared goodness-of-fit test.

### SUMMARY OF THE INVENTION

Some or all of the above needs and/or problems may be addressed by certain embodiments of the disclosure. Certain embodiments can include methods, devices, and systems for fault tolerance in autonomous state estimation of one or more robotic vehicles. According to one embodiment of the disclosure, there is disclosed a method. The method can include training a program, such as a computer program, according to known or estimated behavior of one or more sensors. The method can include receiving, from at least one sensor of one of the vehicles, data detected by a sensor of a proximal environment. The method can then compare and evaluate the sensed data with the training program, and generate an assessment of the accuracy of the sensed data. The method can also determine whether a pre-plotted route of the robotic vehicle should be adjusted based, in part, on the sensed data.

According to another embodiment of the disclosure, there is disclosed a device. The device can include one or a multiple sensors to detect data about the proximal environment of the sensor and the robotic vehicle. The device can include at least one microprocessor to compile the data and to carry out computer instructions stored on at least one computer memory of the device. The computer instructions can include operability to train an electronic program that relates to at least one of the sensors of the vehicle. The instructions can be further operable to evaluate data received by the sensors based, at least in part, on the training program for the respective sensors. The computer-readable instructions can also be operable to generate an assessment of the evaluation of data and program, and then determine a route of the vehicle based on the assessment and the original route.

According to another embodiment of the disclosure, there is disclosed a system. The system can include multiple sensors, of similar or different capabilities, and multiple robotic vehicles. The multiple sensors can reside on a single vehicle or on multiple vehicles. Different sensors can be capable of detecting different data and features of the environment. The system can include at least one microprocessor to compile the data and to execute computer instructions stored on at least one computer memory of the system. The computer instructions can include operability to train an electronic program that relates to one or more of the sensors of one or more of the vehicles. The instructions can be further operable to evaluate data from the sensors based, at least in part, on the training program for the respective sensors. The computer-readable instructions can also be operable to generate an assessment of the evaluation, and determine a route of the vehicle or vehicles based on the assessment and the original routes.

Other embodiments, devices, systems, methods, aspects, and features of the disclosure will become apparent to those skilled in the art from the following detailed description.

### BRIEF DESCRIPTION OF DRAWINGS

The detailed description is set forth with reference to the accompanying drawings, which are not necessarily drawn to scale. The use of same reference numbers in different figures indicate similar or identical terms.

FIG. 1 is a flow diagram of an example method of state estimation of a robotic vehicle, according to an embodiment of the disclosure.

FIG. 2 illustrates a schematic diagram representing a state estimation device, according to an embodiment of the disclosure.

FIG. 3 illustrates a schematic diagram representing an example state estimation system, according to an embodiment of the disclosure.

### DETAILED DESCRIPTION OF THE PREFERRED EMBODIMENTS

In order that the present invention may be fully understood and readily put into practical effect, there shall now be described by way of non-limiting examples of preferred embodiments of the present invention, the description being with reference to the accompanying illustrative figures.

Certain embodiments herein relate to fault-tolerant state estimation of a robotic vehicle. State estimation can be defined as a high-rate process where independently operating sensor processes (likely operating at different rates) each report measurements that are fed into a Bayesian estimator (e.g. KF, EKF, UKF, particle filter, etc.) to correct a model-driven or imu-mechanized (inertial) process model. Each sensor process can accept inputs from a subset of onboard sensors and can be associated (e.g. one-to-one) with a trained classifier (which accepts the same set of inputs) to determine the validity of the measurement stream being observed. A classifier can be trained according to the below methodology and can produce a classification (e.g. Valid, Invalid, Positive, Negative, etc.) that accompanies the measurement into a gating module that takes a course of action based on the assessment.

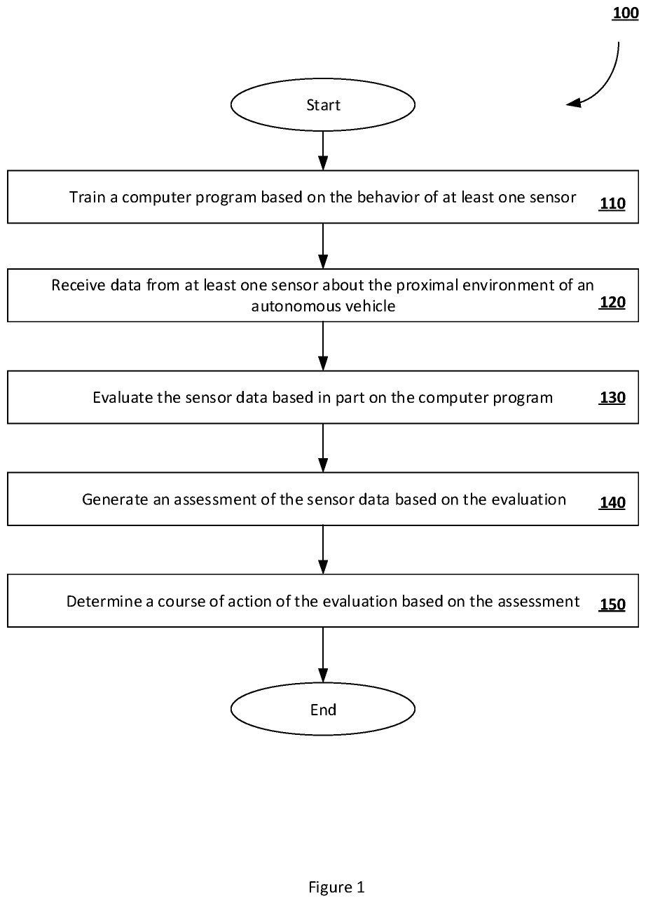

Accordingly, a method can be provided to estimate the state of a robotic vehicle. For example, FIG. 1 is a flowchart illustrating a process 100 for state estimation of a vehicle, according to various aspects of the present disclosure. The process 100 can begin at block 110. At block 110, process 100 can train a computer program according to one or more sensors of the robotic vehicle. For example, process 100 can use one or more data sets to establish, or train, expected sensor readings. In some embodiments, known information about the environment of a robotic vehicle can be used in training the model to establish landmarks and waypoints.

For example, real-world data, such as initial setup information of landmarks and map elements, can be recorded and later accessed by a vehicle for reference. When that vehicle is later mobile, one or more sensors of the vehicle can also detect the presence of the map element. The parameters detected by the sensors can then be compared with the preprogrammed information, which can be used to then assess the accuracy of the sensor readings. Similarly, known information about dimensions and positions of landmarks, and of vehicle environments generally, can inform the training of the comparison model for the vehicle. In some embodiments, simulation data can be used with or instead of real-world data by process 100 to train a sensor model. For example, an environment can be simulated based on known tolerances and logistical requirements. The simulation data can then serve as input to the training/trained model, where the model may be updated dynamically or online depending on the type of machine learning methodology, used to assess a vehicle's sensor readings when in operation. In some embodiments, sensor data that is assessed to be acceptable can then be added to future training. Training models can also include scenarios for multiple types of sensors. For example, different sensors can detect different environmental features. Certain sensors can be more appropriate for a particular vehicle based on, for example, the environments that vehicle will encounter, as well as the specifications for that vehicle's operating abilities.

At block 120, process 100 can receive data from at least one sensor about the environment of the vehicle that is in range of the sensor. In some embodiments sensors can include, GPS location, visible spectrum stereo (or monocular) cameras, thermal imaging, and three-dimensional LiDAR, to name just a few. A vehicle can include all or some of these, as well as other sensors, depending for example on the size and power of the vehicle, and the vehicle's expected need for multiple sensors. In addition to the detection of the environmental features by the one or more sensors, process 100 can include subprocesses for estimating state variables such as stereo visual odometry (“SVO,” from stereo cameras, for example) and monocular visual odometry (“VO,” from thermal imagery, for example) which can produce relatively high-rate velocity and orientation/attitude estimates. These outputs can be reported as observations of the vehicle state. Other sensors, such as three-dimensional LiDAR, can serve as input into LiDAR-based odometry (“LO”) that can provide position estimates at a relatively lower rate. The outputs of the sensor subprocesses can be used as measurement updates into the state estimation pipeline.

In some embodiments, the choice of sensors for a particular vehicle can be complementary, as some sensors combinations perform better under certain conditions. For example, performance of some feature-driven SVO algorithms based upon visible-spectrum imaging may perform poorly in low-light conditions, when variation in lighting is high, or when a sensor is observing a scene with few or no discernable features for reliable tracking. However, in these conditions, thermal VO algorithms can perform better than SVO algorithms if, for example, the features are more easily discerned using thermal imagery. LO algorithms can also perform well in dark conditions since the signal-to-loss ratio of three-dimensional LiDAR increases without ambient light. Even under ideal lighting conditions for all sensing modalities, other factors such as airborne dust, aerosols, and other particulates can affect performance of the sensor stream measurement and the accuracy of their respective subprocess outputs. In conditions of high particulate density, the LO and SVO can degrade in performance. Under these conditions, thermal VO can perform better as the underlying sensor wavelength can better penetrate aerosol and be able to provide inputs that allow more reliable feature extraction. All sensor subprocesses perform well under their respective ideal conditions by providing accurate measurements that can be safely utilized in state estimation.

At block 130, process 100 can evaluate the sensor data based at least in part on the training program. The data sets, simulation and/or real-world, used by the training models can evaluate the consistency of the sensor data, and the data can be relied upon and used for future purposes if consistent. If the sensor data is inconsistent with the training model, the sensor data can be cut off from the rest of the subprocess calculation. Given the sensor subprocesses of SVO, VO, and LO running aboard the autonomous vehicle, process 100 can be employed to determine when the inputs should be gated off as input into the state estimation pipeline. In some embodiments, evaluating the sensor data can occur substantially contemporaneously with receiving the sensor data, and while the sensors continue to receive more data. That is, as soon as a device's electronic circuits permit evaluation of received data, process 100 can proceed with the evaluating step. In other embodiments, sensor data is not evaluated until after the sensors finished receiving data.

At block 140, process 100 can generate an assessment of the sensor data based on the evaluation and comparison of the sensor data with the training model. Whether the training model utilizes simulation data, real-world data, or both, the training model can serve as the classifier for the sensor data. For the purpose of illustration, an autonomous vehicle of process 100 can be analogized with a passenger automobile traveling through, for example, a typical suburban area. For the purpose of training the sensor models, the automobile can be equipped with a highly accurate inertial navigation system for “ground truth.” The automobile can be equipped with sensors to detect environmental data as the operator manually drives through representative environments, and an onboard computer can log visible-spectrum stereo imagery, monocular thermal imagery, and LiDAR point clouds. In this illustration, each input stream can be considered and assessed in isolation. However, input streams are not required to be one-to-one with subprocesses; and the sensor data elements can be labeled as valid or invalid depending on the deviation of the associated subprocess outputs from the signal generated from ground truth. For the purposes of illustration and analogy, it can be seen then that in areas of high particulate density or dust, the performance of LO and SVO may perform poorly, generally, and can be gated off by process 100 in their respective gating subprocess. In some embodiments, if a sensor data stream is assessed as valid, process 100 can then add these sensor data elements to the training model for future training purposes.

At block 150, process 100 can determine a course of action, based at least in part on the assessment. In some embodiments, evaluation of the sensor data relative to the training model can result in a binary assessment, such as ‘valid’ or ‘invalid.’ If the sensor data is assessed as valid, then the sensor data measurement can be fed into the primary state estimator. If the sensor data is assessed as invalid, then the sensor data measurement can be dropped from the state estimation process. In a logic circuit or schematic diagram, the course of action can be an opening or closing of a logic gate depending on the assessment. For example, if the sensor data is assessed valid then the logic gate can be closed to allow for the measurement input to continue through the process. This valid data can then proceed to subsequent stages of the state estimation process 100 that can include controlling the autonomous vehicle via vehicle actuators. If the sensor data is assessed invalid, then the logic gate can be opened which can prevent this sensor data from continuing any further in the state estimation process 100.

The operations described and shown in process 100 of FIG. 1 can be carried out or performed in any suitable order as desired in various embodiments of the disclosure, and process 100 can repeat any number of times. Additionally, in certain embodiments, at least a portion of the operations can be carried out in parallel. Furthermore, in certain embodiments, fewer or more operations than described in FIG. 1 can be performed.

Process 100 can optionally end after block 150.

According to another embodiment of the disclosure, there is provided a device. For example, device 200 can be provided for aiding in the training process to enable state estimation of an autonomous vehicle. Device 200 can include computer and electronic hardware and software necessary or desirable for autonomous vehicle navigation and operation. In some embodiments, device 200 can reside in and/or on the autonomous vehicle. Some examples of types of autonomous vehicles considered here are aerial, terrestrial, marine, and planetary.

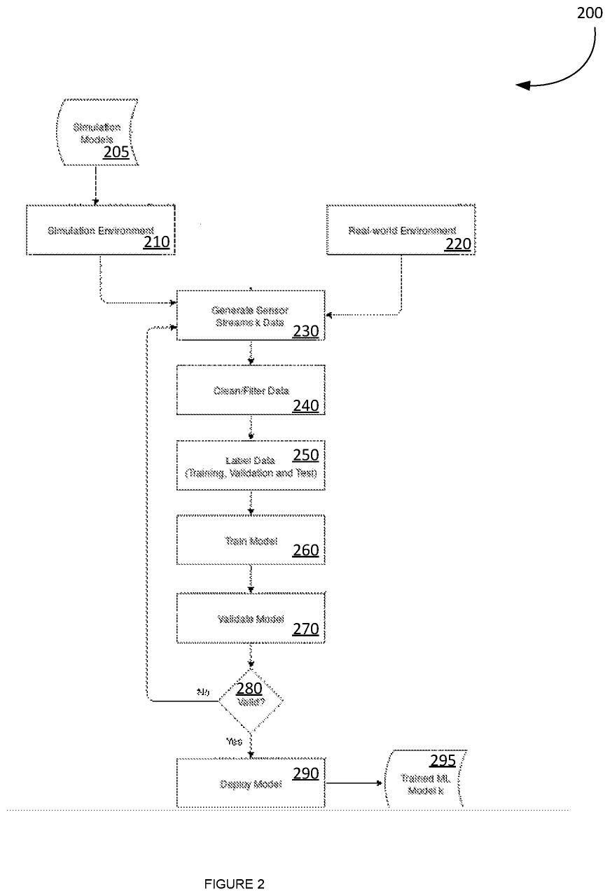

FIG. 2 depicts an example schematic diagram representing one methodology for training and validating machine learning (ML) models used in governing state estimation inputs of an autonomous vehicle. The methodology can be supervised, self-supervised, or use a reinforced learning approach. In some embodiments, one ML model can be trained and deployed for each sensor process. The classifier associated with the ML model can monitor the corresponding input streams and determine whether the inputs will generate a valid state estimator input.

Device 200 can generate sensor data 230 to a process whose classifier will leverage the ML model in question. This data can be simulated 210, for example using simulation models 205, or the data can be taken from real-world 220 measurements. The output of the process can be filtered 240, if necessary, and compared with a reference signal which can be used to assign a label 250 to the input as yielding either a valid or invalid process result. Device 200 can use all or a subsample of the training set as training data in order to train the model 260. In some embodiments, device 200 can then use a different subset, for example a mutually exclusive subset, that is selected for validation. The model is then evaluated 280. If the results are unacceptable then additional and/or new data altogether is generated for the training process to enhance the accuracy of the model's performance. The process continues in this fashion until acceptable model performance is achieved. When the results are acceptable, the model is considered valid and is deployed 290 to the onboard computer system to be utilized by an associated classifier process, for example a trained ML model 295.

Mapping the measurements contained within a process's input stream to a label for the purposes of training a model can require a reference signal, or ground truth signal, with which to compare the process's output. In this framework, for example, the output can be assumed to be an absolute or relative (e.g. odometric) measurement pertaining to a subvector of the vehicle state and a corresponding estimate of measurement uncertainty. When the input data is real-world sensor data, the ground truth signal can be generated from an external system, such as a motion capture system or GPS system. If using simulated sensor streams as process inputs, the ground truth can be obtained directly from the simulation itself. In either case, the following metric can be utilized to determine the validity of a set of input measurements:

z_process(t)−h(x_gt(t))

where z_process(t) denotes the measurement output of the process, x_gt(t) denotes the ground truth state variable, and h( ) denotes the function mapping of the ground truth state variable to a measurement.

According to another embodiment of the disclosure, there is provided a system. For example, system 300 can be provided for state estimation of one or more autonomous vehicles. System 300, by itself or in conjunction with other systems operating in the same or complementary environment, can use sensors and processes that, by themselves, can experience highly degraded performance and/or failure modes that are otherwise difficult to model with traditional techniques. However, system 300 can leverage ML techniques to train a model of acceptable sensor behavior under a variety of environmental conditions. Based on the classified state of the sensor input stream, system 300 can decide whether new measurements are to be integrated as corrections into a Bayesian state estimation process. In some embodiments, multiple autonomous vehicles can be deployed in a given environment. Each autonomous vehicle can include multiple sensors of varying types. System 300 can communicate among and between the vehicles to disseminate information, sometimes newly gathered information, to all vehicles deployed. In this way, even more data and information can be accessible by an individual autonomous vehicle.

System 300 can use a data-drive methodology that employs supervised ML methods and algorithms (e.g. deep learning, deep neural nets, etc.) for training a model whose inputs can be the sensors process streams, and whose output can be a binary decision on whether the measurement should be leveraged by the underlying state estimation pipeline to improve accuracy. As such, system 300 can eliminate explicit assumptions on the nominal behavior and characteristics of these measurement streams and rely instead on the ability of ML to train a more accurate model. One advantage of this approach is that system 300 can yield a more accurate model for capturing nominal system behavior. System 300 can use data ingestion, model training, and model deployment for a variety of applications including character recognition, semantic object recognition (including three-dimensional), natural language processing, facial and gesture recognition, and model-predictive vehicle controls.

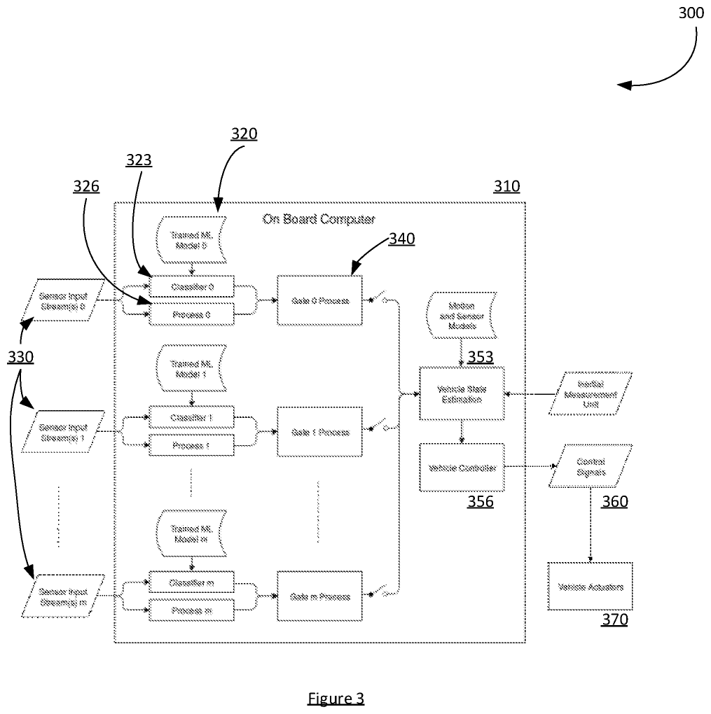

FIG. 3 depicts an example schematic diagram of system 300. One component of system 300 is a gating mechanism 340 that can be driven by classification 323 results derived from models 320 generated from either an offline or online ML algorithm such as that outlined in Process 200. The classification 323 can determine the state of the gate (open or closed) for each input stream 330. An autonomous vehicle can include one or more onboard computers 310 which can include the necessary or desired components for operation including, but not limited to, at least one microprocessor, at least one sensor, at least one memory, and at least one communication device. These components can be in addition to, and complementary with, operational components such as motors and actuators.

System 300 accepts both logged sensor process outputs and corresponding ground truth measurements that can be compared, for example, via equation. Depending on the agreement between the process output and the ground truth signal, the stream 330 can be marked as either valid or invalid and stored in a database of time-stamped labels. These labels can then be used to map sensor process input streams to ground truth labels.

Associated with each sensor process 326, is a collection of input streams 330, which are not necessarily mutually exclusive. In this framework, each process is expected to output an observation of some set of state variables and corresponding uncertainty estimates. Under normal operating conditions in which stream inputs may be ‘clean,’ the output is expected to be usable and can be fed into the vehicle state estimator 353. Each sensor process can be associated with a corresponding classifier process 323 which accepts the same set of sensor input streams. Each classifier 323 can be trained a priori (e.g. supervised) or online (e.g. via reinforcement learning) and is responsible for determining whether given input streams 330 will yield valid process output. Both the classifier output and process output can be time-synchronized and are fed into a corresponding gating process 340 that can connect or disconnect the process output channel into a Bayesian state estimator. By eliminating the erroneous measurements due to unsuitable sensor inputs, system 300 can enable a more robust and accurate computation of the state. The state estimate 353 can be used to “close the loop” with the vehicle controller 356, which can emit a signal 360 that can drive the vehicle's actuation 370.

As desired, embodiments of the disclosure may include devices and systems with more or fewer components than are illustrated in the drawings. Additionally, certain components of the devices and systems may be combined in various embodiments of the disclosure. The devices and systems described above are provided by way of example only.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method for state estimation of an autonomous vehicle, the method comprising:
training, via at least one microprocessor, a model relating to at least one sensor;
receiving, via at least one sensor, data about an environment of the at least one sensor;
evaluating, via the at least one microprocessor, the model and the data;
generating, via the at least one microprocessor, an assessment of the data based at least in part on the evaluating; and
determining, via the at least one microprocessor, a course of action based at least in part on the assessment.

2. The method as recited in claim 1, wherein the model comprises simulation data.

3. The method as recited in claim 1, wherein the model comprises real-world data.

4. The method as recited in claim 1, wherein the at least one sensor is operable to detect at least one of thermal imagery, monocular visual odometry, stereo visual odometry, and LiDAR-based odometry.

5. The method as recited in claim 1, wherein the evaluating occurs substantially contemporaneously with the receiving.

6. The method as recited in claim 1, wherein the assessment is one of positive or negative.

7. The method as recited in claim 1, further comprising merging, via the at least one microprocessor, the model and the data.

8. A device for state estimation of an autonomous vehicle, the device comprising:
at least one sensor to detect data about an environment of the autonomous vehicle;
at least one microprocessor; and
at least one memory storing computer-readable instructions, the at least one microprocessor operable to access the at least one memory and execute the computer-readable instructions to:
train a model relating to the at least one sensor;
evaluate the model and the data;
generate an assessment of the data based at least in part on the evaluating; and
determine a course of action based at least in part on the assessment.

9. The device as recited in claim 8, wherein the model comprises simulation data.

10. The device as recited in claim 8, wherein the model comprises real-world data.

11. The device as recited in claim 8, wherein the at least one sensor is operable to detect at least one of thermal imagery, monocular visual odometry, stereo visual odometry, and LiDAR-based odometry.

12. The device as recited in claim 8, wherein the computer-readable instructions are further operable to evaluate, substantially contemporaneously, the program and the data.

13. The device as recited in claim 8, wherein the assessment is one of positive or negative.

14. The device as recited in claim 8, wherein the computer-readable instructions are further operable to merge the model and the data.

15. A system for state estimation of autonomous vehicles, the system comprising:
a plurality of sensors to detect data relating to at least one environment of the autonomous vehicles;
at least one microprocessor; and
at least one memory storing computer-readable instructions, the at least one microprocessor operable to access the at least one memory and execute the computer-readable instructions to:
train a model based at least in part on the plurality of sensors;
evaluate the model and the data;
generate an assessment of the data based at least in part on the evaluating; and
determine a course of action based at least in part on the assessment.

16. The system as recited in claim 15, wherein the model comprises at least one of simulation data and real-world data.

17. The system as recited in claim 15, wherein the plurality of sensors are operable to detect at least one of thermal imagery, monocular visual odometry, stereo visual odometry, and LiDAR-based odometry.

18. The system as recited in claim 17, wherein the computer-readable instructions are further operable to choose a type of sensor based on the at least one environment.

19. The system as recited in claim 15, wherein the computer-readable instructions are further operable to communicate the data, from at least one of the plurality of sensors, among the autonomous vehicles, substantially contemporaneously with detecting the data by the at least one of the plurality of sensors.

20. The system as recited in claim 15, wherein the computer-readable instructions are further operable to evaluate, substantially contemporaneously, the model and the data.
